(19) United States
(12) Patent Application Publication
(10) Pub. No.: US 2017/0021744 A1
(43) Pub. Date: Jan. 26, 2017

(54) Booster Belt

(71) Applicants: Varinder Singh Sanghera, Surrey (CA); Gurprit Singh Dhaliwal, New Westminster (CA)

(72) Inventors: Varinder Singh Sanghera, Surrey (CA); Gurprit Singh Dhaliwal, New Westminster (CA)

(21) Appl. No.: 14/809,257

(22) Filed: Jul. 26, 2015

(51) Int. Cl. B60N 2/28; F16B 1/00

(52) U.S. Cl. CPC B60N 2/2812; F16B 1/00; B60N 2/2866; F16B 2001/0035; B60N 2002/2815

(57) ABSTRACT

Vehicle seatbelts are designed to increase the likelihood of passenger survival in the case of a crash or collision. The optimal positioning of a vehicle seatbelt is over a passenger's shoulder, across their chest and upper thighs. Children weighing between 18 and 36 kg should be placed in a booster seat in order to raise them up to an appropriate height so that the adult seatbelt may protect them better. The current design of booster seats makes it difficult for children to buckle themselves into a vehicle and thus requires an adult to reach around the child and buckle them in. The current design of booster seats also does not ensure that the lap belt portion of a seatbelt will not move up to the lower abdomen of a child under normal driving conditions. The addition of a booster belt to a child booster seat will address both of the above-mentioned inconveniences and safety concerns with existing booster seat designs. Attracting magnetic materials will be used to set the female buckle on the booster belt in a more favourable position on the booster seat. This allows for easy buckling of the belt by children and ensures the lap belts are correctly positioned for safety. The lap belt will cross the child's upper thighs and eliminate risk of the belt moving into the child's lower abdomen while seated in normal driving conditions.

### FIELD OF INVENTION

The invention relates to a child's booster seat for vehicles. More specifically, it relates to a seat belt booster belt that attaches to a booster seat through magnetic and ferrous materials.

### BACKGROUND OF INVENTION

Most motor vehicle acts in the United States and Canada are written to ensure optimal passenger safety in the event of a crash or collision. Under several of these acts, child booster seats are required for children under the age of 8, weighing between 18 and 36 kg and less than 145 cm tall. The purpose of the child booster seat is to raise the child up from the standard vehicle seat in order to increase the likelihood of survival in a motor vehicle accident. Vehicle seatbelts are designed to cross passengers' shoulders, chests and upper thighs, as these areas of the body are considered to be better able to resist the force of a collision. Given the smaller stature of most children, they require the additional height a booster seat provides in order for the vehicle seatbelt to function correctly.

The booster seat is a seat that is placed upon a vehicle's seat to raise a child up several inches. Currently, booster seats are available with a high back (intended for vehicles without a headrest) or backless (for vehicles with a headrest). Some models of booster seats are designed to include a guiding system, intended to guide the seatbelt in the correct position; however, these guiding systems do not always function as intended. The drawbacks of current booster seat designs are: they don't allow for children to buckle themselves into a vehicle; they don't ensure the lap belt portion of a vehicle's seatbelt will not move into the lower abdominal region of a child during normal vehicle operation; they require an assisting party to buckle the child into the vehicle.

The primary objectives of the invention are to allow children to be able to buckle themselves into a vehicle when placed in a booster seat and to ensure the correct placement of the vehicle's seatbelt. This saves time, promotes independence and increases safety. With the booster belt, children will be able to take the vehicle's seatbelt and buckle it into the booster belt's female connector without requiring an assisting party. Attaching the female connector of the booster belt directly to the booster seat will also guide the lap belt to rest over the child's lower lap and keep the lap belt in this position, thus meeting the guidelines outlined in the Motor Vehicle Act.

Requiring an assisting party to buckle a child into a booster seat can be time consuming and physically straining. The assisting party must reach around the child in the booster seat with the seatbelt and connect it to the female booster belt. This process is made more difficult by the recessed female seatbelt connectors found in most new vehicles, as they are difficult to access by an assisting party from outside the vehicle. Furthermore, most booster seats are not permanently secured in a vehicle and therefore may move over the vehicle's female buckle, making it more difficult for the child to be buckled into the vehicle. Having a larger child or a limited amount of room in the vehicle may further complicate this process. The traditional booster seat can be very inconvenient, time consuming and physically harmful as for the assisting party who is required to bend over awkwardly to buckle the child.

### SUMMARY OF INVENTION

The booster belt is comprised of both a male and female connector that are joined together with a booster belt strap. The male connector of the booster belt will connect directly to the female connector of the vehicle's seatbelt system and the female portion of the booster belt will connect to the booster seat via magnets. The booster belt strap will be attached to the female connector by the booster belt metal piece.

The booster belt strap is the part that will connect the male and female portions of the booster belt together. It is designed to have limited flexibility in order to ensure the performance of the vehicle's seatbelt system is not hindered in the event of a crash or collision. The booster belt strap is designed as such that it may function on either the left or right side of the booster seat.

Magnets will be placed on the backside of the female connector as well as the booster seat itself. The magnets on the booster belt will utilize a two-tier design, which will also serve as the connection point for the booster belt strap. This will allow the booster belt strap to swivel from left to right, therefore allowing it to work on either side of the booster seat.

Magnets will also be placed on either side of the booster seat and these will serve as the connection points for the booster belt. The placement of the magnets on the booster seat will serve two purposes: to connect the booster belt to the booster seat; to ensure the lap belt portion of the vehicle's seatbelt remains over the lower hip region of the passenger during normal driving conditions.

The booster belt is designed for use exclusively with a children's booster seat. The advantages provided by the booster belt are: children are able to buckle themselves into a vehicle thus eliminating the need for an assisting party; the booster belt provides improved placement of the lap belt portion of the seatbelt, thereby meeting MVA safety recommendations; in the event of a crash or collision, the magnets on the booster belt will disengage from the booster seat, thus allowing the vehicle's seatbelt to function to the manufacturer's safety specifications; the booster belt may be placed on either the right or left side of the booster seat and therefore allows the booster seat to be placed behind the driver or passenger side of a vehicle;

Children spend several years using a booster seat in a vehicle and this is often a time when they begin to look to assert their independence. Booster seats are designed to add several inches to the height of a child sitting in a vehicle. This added height makes it difficult for children to reach the female connector of the vehicle's seatbelt system. The female connector is often recessed in the vehicle or it may become trapped under the booster seat itself. The booster belt addresses this inconvenience by placing a female connector directly on the booster seat, thereby making it easily accessible to the child to buckle the seatbelt. This not only saves time, but also allows the child to be more independent.

The current design of booster seats requires an assisting party to buckle a child into a vehicle. This problem is further exacerbated in smaller vehicles, where there is limited space for a person to reach around a child, locate the vehicle's female connector and buckle the child in. This process can be time consuming and cause physical strain or injury to the assisting party. The booster belt addresses these issues with the placement of the booster belt's female connector on the booster seat. If for any reason a child is unable to buckle themselves, an assisting party can buckle the child quickly and with limited to no physical strain.

The magnetic materials on the booster belt and the booster do not permanently secure the seat belt booster belt to the booster seat. This design allows the booster belt to be detached from the booster in the event of a collision. The advantage of this design is the vehicle seat belt is allowed to perform its purpose and minimize injury to the child during a collision. The purpose of the magnet is to place the female buckle, on the booster belt, for convenience and preferred lap belt positioning but not affect the safety features of a shoulder and lap belt attached to a vehicle.

One of the benefits of booster seats are they may be placed on either the right or left side of a vehicle. This allows users to place several booster seats in one vehicle if necessary. The booster belt is designed to allow the male connector to swivel from left to right, thereby allowing it to be attached to either side of the booster seat. This design allows the booster to be placed on either side of the vehicle.

### DESCRIPTION OF DRAWINGS

FIG. 1—depicts the front view of a child in a booster seat with the magnetic seat belt booster belt and booster seat.

FIG. 2—depicts the side view of a child in a booster seat with the magnetic seat belt booster belt and booster seat.

FIG. 3—depicts the magnetic seat belt booster belt and the booster unattached. The picture shows the where the magnetic pieces would be placed for the booster seat and the seat belt booster belt.

FIG. 4—depicts the magnetic seat belt booster belt and booster seat becoming de-attached in a collision scenario with a child in the booster seat.

FIG. 5—depicts how the seat belt booster belt (female piece) is connected to the belt strap and the magnetic piece.

### DETAILED DESCRIPTION OF THE INVENTION

The present invention covers integral, semi-integral and non-integral means for adding a seat belt extender connector to a booster seat. Accordingly this invention may apply to child booster seats manufactured and sold with the seatbelt extenders described herein, or the seatbelt extenders may be manufactured separately (semi-integral) from the booster seat but be included as a component of the booster seat. Additionally, seatbelt extenders may be manufactured, packaged and sold separately from the booster seat (non-integral). This option will allow consumers to add the booster belt to previously purchased booster seats, thus preventing the need to purchase a new booster seat.

Devices and methods discussed herein are merely illustrative of specific manners in which to make and use this invention and are not to be interpreted as limiting scope. The device and details have been described with a certain degree of particularity. It is to be noted that many modifications may be made in the details of the construction and the arrangement of the devices and components without departing from the spirit and scope of this disclosure. An improved product may be constructed of any suitable material or through methods such as plastic mouldings. The present invention shows circular shapes, however, other shapes are contemplated including circular, triangular, square and rectangle shapes.

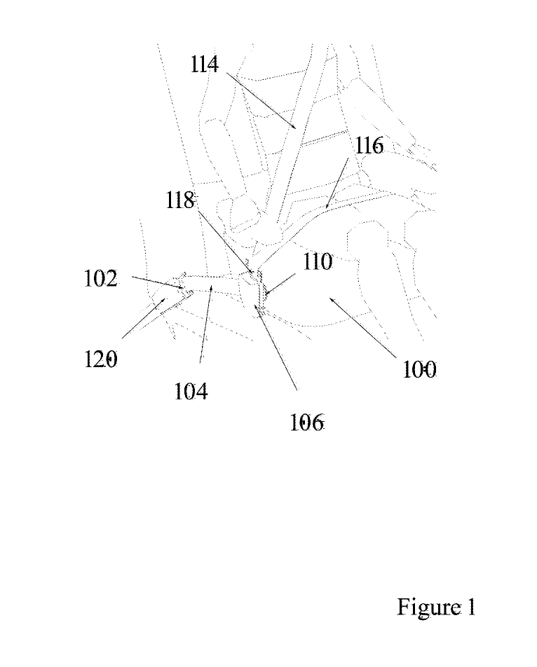

FIG. 1 shows a child sitting in a booster seat (100) while using the vehicle's seat belt. The booster belt (122) is attached to side of the booster seat (100) using magnets (112). The position of the booster belt (122) makes it easily accessible for the child or for an adult assisting the child with their seatbelt. The placement of the booster belt (100) also helps to position the vehicle's should belt (114) across the chest of the child and the lap belt (116) across the upper thighs of the child. The male connector (118) of the vehicle's seat belt is clipped into the booster belt female connector (106) and the booster belt male connector (102) is connected to the vehicle female connector (120).

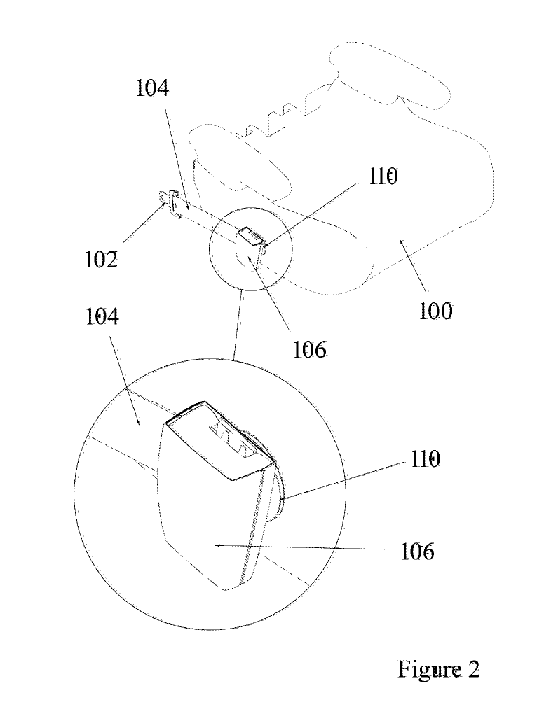

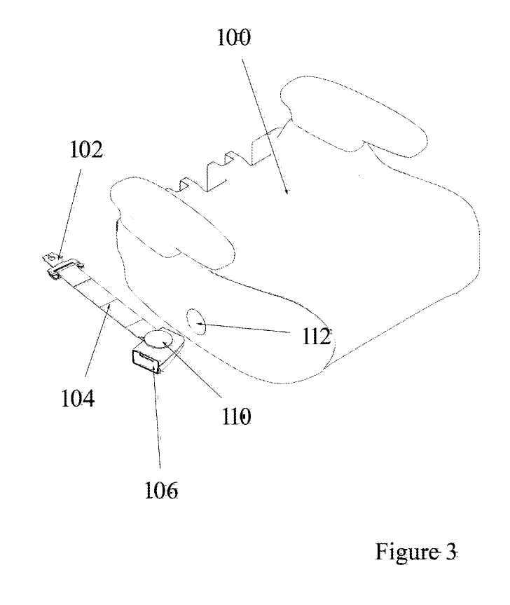

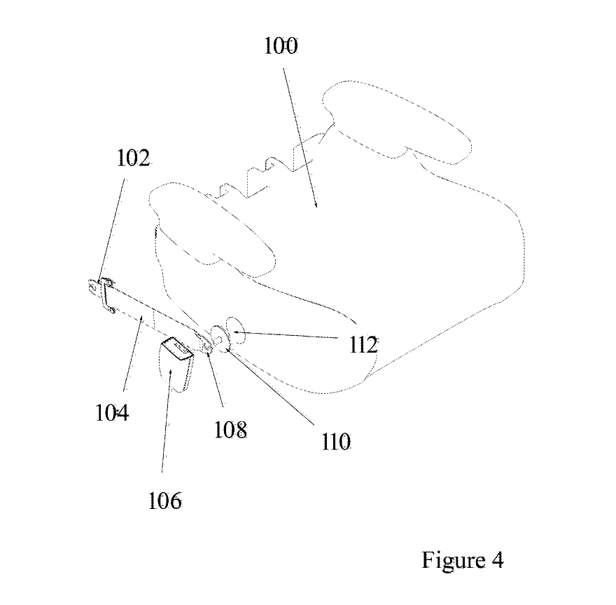

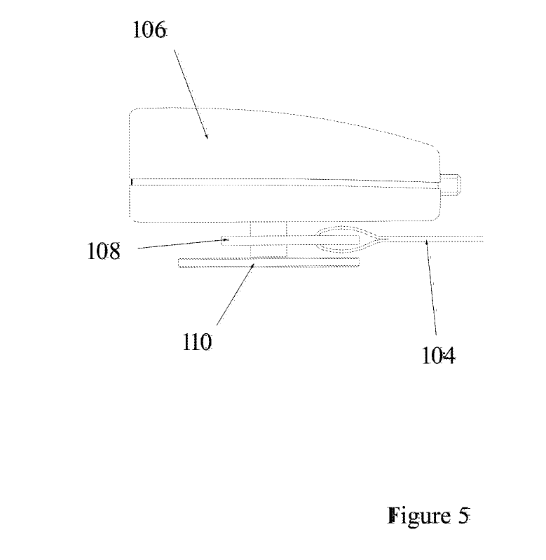

FIG. 2 shows the booster belt connected to the booster seat (100). The booster belt female connector (106) is positioned on the side of the booster seat (100). This position of the booster belt female connector (106) makes it easily accessible to the child sitting in the booster seat, thereby enabling them to buckle themselves in. It is also an ideal position for a child needing third party assistance to buckle the seatbelt. The booster belt female connector (106) is easily accessible to an adult and alleviates the strain required to buckle a child into a booster seat that does not have a booster belt.
FIG. 2A shows how the booster belt female connector (106) attaches to the booster seat using a metallic connector (110).
FIG. 3 shows the parts of the booster belt (122). The booster belt (122) is comprised of a male connector (102) that connects the booster belt to the vehicle's female connector. The booster belt strap (104) connects the booster belt male connector (102) to the booster belt female connector (106). The booster belt female connector (106) has a ferrous metal piece (110) attached to it. This ferrous metal piece (110) will connect to the booster seat magnet (112) which is located on the booster seat (100).
FIG. 4 further illustrates the different aspects of the booster belt (122). The booster belt strap (104) has a metal swivel (108) on one end, which allows the strap to rotate 360 degrees on the booster belt female connector (106). This allows the booster belt to work on either side of the booster seat, thus allowing the booster seat to be placed on either side of the vehicle.
FIG. 5 shows the booster belt female connector (106). The booster belt strap (104) has a metal swivel (108) on one end, which allows the booster belt strap (104) to rotate 360 degrees on the booster belt female connector (106). The booster belt metal swivel (108) has a hole through the center, allowing the booster belt metal piece (110) to pass through it and connect to the booster belt female connector (106).

We claim:

1. A magnetic seat belt extender and a booster seat, comprising:
An elongate anchor extension of limited flexibility, have a first end a second end opposite said first end;
A male seatbelt latch tongue immovably fixed to and extending from said first end of said anchor extension; and
A female seatbelt latch receptacle immovably affixed to and extending from said second end of said anchor extension;
A magnet immovably affixed to the female seat belt latch receptacle.

2. A seat belt extender according to claim 1, wherein said anchor extension comprises a flat strap having a cover selected from materials consisting of rubber and plastic and/or metal.

3. The seat belt extender according to claim 2 wherein said strap is formed of polyester or nylon webbing material.

4. The seat belt extender according to claim 1 wherein said anchor extension comprises a cable having a cover selected from the materials consisting of rubber and plastic and/or metal.

5. The seat belt extender according to claim 4 wherein said cable is formed of strands selected from the group consisting of steel and synthetic fibre material.

6. The seat belt extender according to claim 1 wherein said anchor extension is between 1 inches and 8 inches in length.

7. The seat belt extender according to claim 1 wherein the magnetic piece is comprised of magnetic or ferrous material will be affixed to the female seat belt latch receptacle.

8. The seat belt extender according to claim 1 wherein the magnetic piece comprised of magnetic or ferrous material will be between 0.5 inches to 2 inches in diameter.

9. The seat belt extender according to claim 1 wherein the female seat belt latch receptacle will be attached to the magnetic piece using a bolt comprising of metal and between 0.25 inches and 2 inches in length.

10. A magnetic booster seat comprising;
A standard booster seat with or without a back;
A magnetic or ferrous material on either side of the booster seat for connection to the magnetic or ferrous material on the female latch receptacle as mentioned in claim 7;
